(19) United States
(12) Patent Application Publication
(10) Pub. No.: US 2010/0145672 A1
(43) Pub. Date: Jun. 10, 2010

(54) MICROCOMPUTER AND EMBEDDED SOFTWARE DEVELOPMENT SYSTEM

(75) Inventor: Tzu-hsiang YEN, Kanagawa (JP)

Correspondence Address: YOUNG & THOMPSON, 209 Madison Street, Suite 500, Alexandria, VA, 22314, US

(73) Assignee: NEC ELECTRONICS CORPORATION, Kanagawa (JP)

(21) Appl. No.: 12/631,277

(22) Filed: Dec. 4, 2009

(30) Foreign Application Priority Data
Dec. 4, 2008 (JP) 2008-309702

(51) Int. Cl. G06F 9/455; G06F 19/00

(52) U.S. Cl. 703/28; 702/108

(57) ABSTRACT

In an aspect of the present invention, a microcomputer includes a CPU core section, and a plurality of external input terminals. A testing section selects a selection external input terminal from the plurality of external input terminals, detects an intermediate voltage of the selection external input terminal, and outputs an interrupt processing signal related to the detection of the intermediate voltage to the CPU core section.

### INCORPORATION BY REFERENCE

This patent application claims a priority on convention based on Japanese Patent Application No. 2008-309702. The disclosure thereof is incorporated herein by reference.

### BACKGROUND OF THE INVENTION

1. Field of the Invention

The present invention relates to a microcomputer and an embedded software development system, and more particularly, to a microcomputer that can detect an intermediate voltage and an embedded software development system for the same.

2. Description of Related Art

In a microcomputer, if a voltage level at an input terminal is brought to an intermediate voltage level, there may arise problems, i.e., a through-current flowing in a circuit increases to break down an electronic device or an entire circuit, and the other problems. Accordingly, to handle such problems, a technique is required that can detect that the voltage level at the input terminal is in the intermediate voltage level, at an early stage (e.g., when embedded software is developed).

Also, in recent years, an embedded system embedded in a microcomputer becomes complicated and larger in size. Accompaniment with this, a debugging period for the embedded system becomes longer. Accordingly, it is demanded to shorten the debugging period by detecting a hardware problem such as input of the intermediate voltage during the debugging period.

Further, along with the above-described increases in complexity and a size of the embedded system, the requirement of reliability such as a self-diagnosis function by a device itself is also increased. For example, when a problem is found out in the microcomputer, even after delivery of a set product mounted with a microcomputer, it is required that the system can be safely stopped.

A technique about the intermediate voltage level at the input terminal in a semiconductor integrated circuit is described in Japanese Patent Application Publication (JP 2004-186184A: first conventional example). In the semiconductor antegrated circuit, a signal supplied to an input terminal is received by a CMOS inverter. The semiconductor integrated circuit includes a detecting circuit, a monitoring circuit, and a clamping circuit. The detecting circuit detects transition of a voltage level at the input terminal (input pad) to an intermediate voltage level of a power supply voltage. The monitoring circuit monitors continuous detection of the intermediate voltage level by the detecting circuit for a specified period. The clamping circuit pulls up the voltage level at the input terminal to the power supply voltage level, or pulls down it to a ground voltage level when the monitoring circuit confirms the specific period continuation.

The semiconductor integrated circuit in the first conventional example automatically pulls up the voltage at an input terminal when an intermediate voltage is detected. That is, the intermediate voltage is automatically avoided on the hardware. However, the semiconductor integrated circuit does not have a scheme that notifies the generation of the intermediate voltage to a software development system (or a developer) or software. For example, when the intermediate voltage is supplied to the input terminal from an external component, the generation of the intermediate voltage is caused by the external component. However, the semiconductor integrated circuit does not output a warning, and therefore cannot recognize the generation of the intermediate voltage on the software development system or software. For this reason, the developer cannot take essential measures.

It could be considered that this is because an object of the first conventional example is to reduce damage that occurs in a microcomputer by the generation of the intermediate voltage, as much as possible, and therefore, to emphasize that the intermediate voltage is changed to a predetermined high or low level in the case of the generation of the intermediate voltage. Accordingly, the semiconductor integrated circuit does not have the scheme notifying the developer or software$ and therefore cannot find the problem early, or take the safe measures on the software. Such generation of the intermediate voltage leads to an increase in a debugging period. As a result, a development time for an embedded system is increased.

Also, the semiconductor integrated circuit cannot notify the generation of the intermediate voltage as described above, and therefore when being brought into a state that the intermediate voltage is to be inputted by a defective component, deterioration or disturbance after delivery of a set product mounted with the microcomputer, cannot take even a minimum measure (e.g. a measure in which a malfunction is notified to a user of the microcomputer with lighting of a lamp or other measure). For this reason, a problem will occur in a system using the chip set.

### SUMMARY OF THE INVENTION

In an aspect of the present invention, a microcomputer includes a CPU core section, a plurality of external input terminals; and a testing section configured to select a selection external input terminal from the plurality of external input terminals, detect an intermediate voltage of the selection external input terminal, and output an interrupt processing signal related to the detection of the intermediate voltage to the CPU core section.

In another aspect of the present invention, an embedded software development system includes a debugging target circuit configured to emulate an operation of a microcomputer as a target of a debugging operation; a debugger to which the debugging target circuit is connected; and a testing section connected with a plurality of external input terminals of the debugging target circuit, and configured to select a selection external input terminal from the plurality of external input terminals, detect an intermediate voltage of the selection external input terminal, and output an intermediate voltage detection signal to the debugger to indicate the intermediate voltage.

According to the present invention, the generation of an intermediate voltage in a microcomputer can be recognized. Also, a development time can be shortened, and reliability of a system can be improved.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a block diagram illustrating a configuration of a microcomputer and an embedded software development system according to first and second embodiments of the present invention;

FIG. 2 is a block diagram illustrating respective configurations in a check circuit according to first and third embodiments of the present invention;

FIG. 3 is a circuit diagram illustrating an example of an intermediate voltage detection part according to the first to third embodiments of the present invention;

FIG. 4 is a flowchart illustrating operations of a microcomputer and an embedded software development system according to the first and third embodiments of the present invention;

FIG. 5 is a flowchart illustrating processing for the case where the intermediate voltage is detected, according to the first and third embodiments of the present invention;

FIG. 6 is a block diagram illustrating respective configurations in the check circuit according to the second and third embodiments of the present invention;

FIG. 7 is a flowchart illustrating the operations of the microcomputer and the embedded software development system according to the second and third embodiments of the present invention; and

FIG. 8 is a block diagram illustrating a configuration of the software development system according to the third embodiment of the present invention.

### DESCRIPTION OF PREFERRED EMBODIMENTS

Hereinafter, a microcomputer and an embedded software development system according to the present invention will be described with reference to the attached drawings.

### First Embodiment

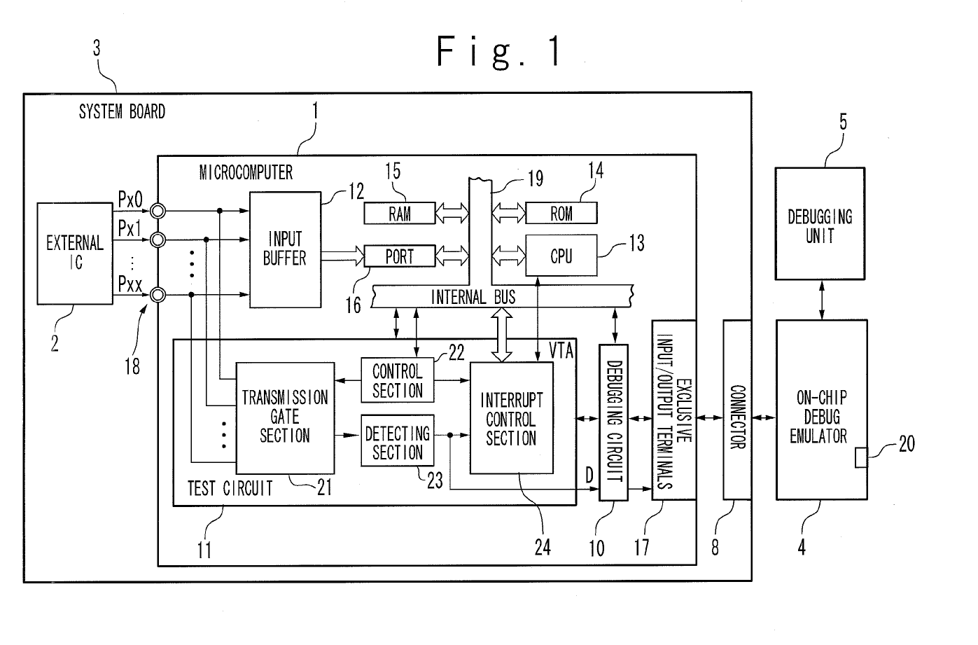

FIG. 1 is a block diagram illustrating a configuration of the microcomputer and the embedded software development system according to the first embodiment of the present invention. Referring to FIG. 1, the microcomputer 1 according to the present embodiment is mounted on a qsystem board 3 along with an external IC (integrated Circuit) 2. The system board 3 including the microcomputer 1 and the external IC 2 operates as a microcomputer system.

The embedded software development system according to the present embodiment includes a debugging unit 5 as a debugger, and an on-chip debug emulator 4. The debugging unit 5 is exemplified by a personal computer and an information processing apparatus having a display unit. The information processing apparatus is loaded with debugging software, and functions as the debugger. The embedded software development system performs software debugging and hardware operation check on the above microcomputer system as an evaluation target. Also, the debugging unit 5 has a warning function, i.e., a function to display an intermediate voltage detection signal D (to be described later), which is outputted from the microcomputer 1 and indicates the generation of an intermediate voltage, on the display unit as a warning.

The on-chip debug emulator 4 has a function as an interface between the microcomputer 1 and the debugging unit 5. That is, the on-chip debug emulator 4 mediates transmission/reception of data or an instruction between the microcomputer 1 and the debugging unit 5 during debugging by the debugging unit 5. The on-chap debug emulator 4 includes an ALARM lamp (exemplification: LED) 20 that lights in response to the intermediate voltage detection signal D outputted from the microcomputer 1.

The microcomputer 1 includes external input terminals 18, an input buffer 12, a test circuit 11, a debugging circuit 10, a CPU (Central Processing Unit) 13, a ROM (Read Only Memory) 14, a RAM (Random Access Memory) 15, a PORT 16, and an internal bus 19.

The plurality of external input terminals 18 (Px0 to Pxx) are provided at an outer peripheral portion of the microcomputer 1. The external input terminals 18 receive signals from the external IC 2 to take them into the input buffer 12. The voltages at the external input terminals 18 are monitored by the test circuit 11. The microcomputer 1 may have an input/output terminal section (e.g. a dedicated input/output terminal section 17) that inputs/outputs a signal from/to the outside.

The CPU 13 controls an operation of the microcomputer 1. The CPU 13 is connected to the components such as the ROM 14, the RAM 15, the PORT 16, the test circuit 11, and the debugging circuit 10 inside the microcomputer 1 through the internal bus 19 so as to be bi-directionally communicable. The ROM 14 is a memory that stores software executed by the CPU 13. The RAM 15 is a memory that is used when the CPU 13 executes the software stored in the ROM 14. The PORT 16 is a memory that stores (receives) signals (data) supplied from the external IC 2 into the microcomputer 1 through the external input terminals 18 and the input buffer 12. The internal bus 19 mediates data transmission/reception among the components inside the microcomputer 1, including the CPU 13, the ROM 14, the RAM 15, the PORT 16, the test circuit 11, and the debugging circuit 10.

The debugging circuit 10 has a function of debugging the software installed in the microcomputer (exemplification: ROM 14). The debugging unit 5 can control an operation of the debugging circuit 10 through the on-chip debug emulator 4, and acquire various data in the microcomputer 1 being debugged.

The test circuit 11 is connected to the external input terminal group 18, and selects selection external input terminal from the external input terminal group 18 to monitor a voltage at the selection external input terminal. Also, the test circuit 11 has a function of outputting a warning when detecting the intermediate voltage level at the selection external input terminal. The warning is an interrupt processing signal VTA to be described later, or the intermediate voltage detection signal D. The warning is outputted to the on-chip debug emulator 4 and the debugging unit 5 through the debugging circuit 10. Specifically, the test circuit 11 notifies the CPU 13 of the interrupt processing signal VTA associated with the detection of the intermediate voltage. The interrupt processing signal VTA is exemplified by, for example, a vector table address signal (to be described later). Through the notification of the interrupt processing signal VTA, the CPU 13 can perform a predetermined process to the generation of the intermediate voltage for a microcomputer system. As a result, stability and reliability of the microcomputer system can be increased.

Further, the test circuit 11 notifies the interrupt processing signal VTA to the CPU 13, and also outputs a detection signal (intermediate voltage detection signal D) to the on-chip debug emulator 4 to indicate the detection of the intermediate voltage. Thus, the detection of the intermediate voltage can be notified to a software developer who is developing the microcomputer system by use of the debugging unit 5, through the lighting of the ALARM lamp 20 of the on-chip debug emulator 4. Alternatively, the debugging unit 5 receives the warning through the on-chip debug emulator 4 to display it on a display screen, so as to make it possible to notify the detection of the intermediate voltage to the software developer. As the results of these processing steps, the developer can take essential measures to shorten a debugging period and a development time for the embedded system.

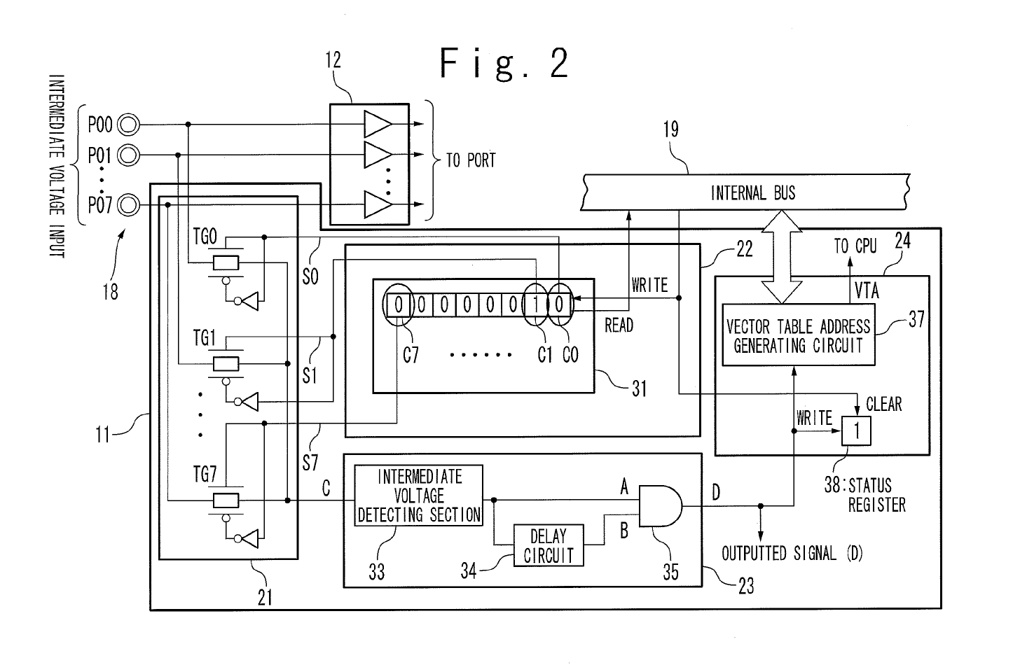

Next, details of the test circuit 11 are described. FIG. 2 is a block diagram illustrating an example of a circuit configuration of the test circuit 11 according to the first embodiment of the present invention. The test circuit 11 includes a transmission gate section 21, a control section 22, a detecting section 23, and an interrupt control section 24. The example of the diagram illustrates the case where the number of the external input terminals 18 is eight; however, the present embodiment is not limited to the case.

The transmission gate section 21 selects one selection external input terminal from the external input terminal group 18 on the basis of a selection signal from the control section 22 to output a voltage (signal) at the selection external input terminal to an intermediate voltage detecting section 33 (to be described later) of the detecting section 23. That is, the transmission gate section 21 has a plurality of transmission gates (analog switches). The plurality of transmission gates are respectively provided for the external input terminals 18, and connected to them. In the example of the diagram, the eight transmission gates (TG0 to TG7) are provided for the eight external input terminals 18 (P00 to P07). Also, the external input terminals P00 to P07 are respectively connected to the transmission gates TG0 to TG7. Further, the plurality of transmission gates are connected to the input buffer 12 in parallel to the external input terminals 18 (more than one). That is, the transmission gates TG0 to TG7 are connected to the input buffer 12 in parallel to the external input terminals P00 to P07.

Each of the plurality of transmission gates is supplied with a selection signal S from the control section 23, and turned ON in response to the selection signal S. In the example of the diagram, the transmission gates TG0 to TG7 are supplied with selection signals S0 to S7 from the control section 22, and turned ON in response to the selection signals S0 to S7, respectively. The transmission gates TG0 to TG7 are turned ON to electrically connect between the external input terminals P00 to P07 and the detecting section 23, respectively.

The control section 22 outputs the selection signal S to the transmission gate section 21 to select one selection external input terminal from the external input terminals 18. That is, the control section 22 has a memory 31 into and from which the CPU 13 can perform write and read. The memory 31 stores data having transmission gate permission bits corresponding to the external input terminals 18. In the example of the diagram, data (01000000) having the transmission gate permission bits (C0 to C7 bits) is stored in correspondence to the eight external input terminals 18 (P00 to P07). The data of the transmission gate permission bits is written and read by the CPU 13 in software.

The control section 22 outputs the selection signal S to a transmission gate corresponding to a transmission gate permission bit of “1” in the stored data. A corresponding transmission gate is turned ON in response to the selection signal S and one selection external input terminal is selected from among the external input terminals 18. That is, a voltage C at the selection external input terminal among the external input terminals 18 is outputted to the detecting section 23 in response to the selection signal S. In the example of the diagram, “1” is stored in the C1 bit, and therefore the control section 22 outputs the selection signal S1 to the transmission gate TG1. In this case, the external input terminal P01 is selected as the selection external input terminal. Then, the transmission gate TG1 is turned ON to thereby establish an electrical connection between the external input terminal P01 and the detecting section 23. As a result, the detecting section 23 starts to detect and monitor the voltage at the external input terminal P01.

The detecting section 23 monitors a voltage C at an external input terminal 18 (selection external input terminal), which is outputted from any of the transmission gates TG, to detect the generation of the intermediate voltage. Then, when the voltage C at the selection external input terminal becomes equal to the intermediate voltage, the detecting section 23 outputs the intermediate voltage detection signal D indicating the detection of the intermediate voltage to the interrupt control section 24 and the other circuits such as the debugging circuit 10, the on-chip debug emulator 4, and the debugging unit 5. The detecting section 23 includes the intermediate voltage detecting section 33, a delay circuit 34, and an AND circuit 35.

The intermediate voltage detecting section 33 is supplied with the voltage C at the selection external input terminal, and when the voltage becomes equal to an intermediate voltage within a predetermined voltage range, outputs a detection signal A to indicate the detection of the intermediate voltage. The delay circuit 34 generates a delay signal B, which is obtained by delaying the detection signal A outputted from the intermediate voltage detecting section 33 by a predetermined delay time (exemplification: 1 msec), and outputs it to the AND circuit 35. The AND circuit 35 outputs a result of an AND operation of the detection signal A from the intermediate voltage detecting section 33 and the delay signal B from the delay circuit 34 as an intermediate detection signal D. That is, when both of the detection signals A and B are in a high level, the intermediate voltage detection signal D is outputted. Thus, when the selection external input terminal is continuously brought to the intermediate voltage for a period of the delay time, the AND circuit 35 will output the intermediate voltage detection signal D. As a result, erroneous detection of the intermediate voltage, for example, temporary generation of the intermediate voltage due to noise, or an input having a slow rise or fall characteristic, can be prevented. The intermediate voltage detection signal D is outputted to the interrupt control section 24 and the outside.

The interrupt control section 24 notifies the interrupt processing signal VTA to the CPU 13 in response to the intermediate voltage detection signal D. The interrupt control section 24 includes a status register 38 and a vector table address generation circuit 37.

In the case where the intermediate voltage is detected and the intermediate voltage detection signal D is outputted, the interrupt status register 38 stores “1” (sets an interrupt status flag) in response to the intermediate voltage detection signal D. “1” indicates the detection of the intermediate voltage. The CPU 13 reads the stored data, and then clears the data for the interrupt status register 38. The vector table address generating circuit 37 generates the interrupt processing signal VTA in response to the intermediate voltage detection signal D to output it to the CPU 13. The interrupt processing signal VTA is a vector table address signal to indicate an address of vector interrupt process that performs a process for the case of the intermediate voltage generation. Thus, even embedded software can detect a hardware malfunction, and therefore appropriate handling can be performed.

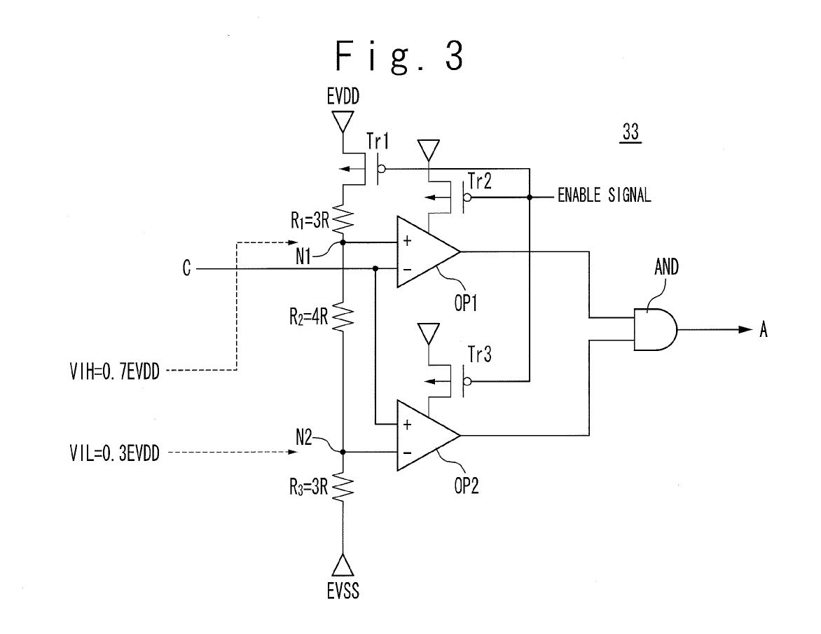

FIG. 3 is a circuit diagram illustrating an example of the intermediate voltage detecting section according to the first embodiment of the present invention. The intermediate voltage detecting section 33 includes PMOS transistors Tr1, Tr2, and Tr3, operational amplifiers (comparators) OP1 and OP2, resistors R₁, R₂, and R₃, and an AND circuit. The PMOS transistor Tr1 has a source connected to a power supply EVDD, a drain connected to one of terminals of the resistor R₁, and a gate connected to a wiring line for an enable signal. The resistor R₁ is connected to a node N1, and a non-inversion input terminal of the operational amplifier OP1 at the other terminal thereof. The resistor R₃ is connected to the node N1 at one terminal, and a node N2 and an inversion input terminal of the operational amplifier OP2 at t′e other terminal. The resistor R₃ is connected to the node N2 at one terminal thereof, and to the other power supply EVSS at the other terminal thereof. The PMOS transistor Tr2 has a source connected to a power supply, a drain connected to a power supply terminal of the operational amplifier OP1, and a gate connected to a wiring line for an enable signal. The operational amplifier OP1 is connected to an output of the transmission gate section 21 at an inversion input terminal thereof, and to one of inputs of the AND circuit at an output thereof. The PMOS transistor Tr3 has a source connected to a power supply, a drain connected to a power supply terminal of the operational amplifier OP2, and a gate connected to a wiring line for the enable signal. The operational amplifier OP2 is connected to an output of the transmission gate section 21 at a non-inversion input terminal thereof, and to the other input of the AND circuit at an output thereof. An output of the AND circuit serves as an output of the intermediate voltage detecting section 33.

The resistors R₁, R₂, and R₃ are connected in series, and divide a voltage of a power supply to generate reference voltages. In the example of the diagram, a ratio of them is R1:R2:R3=3R:4R:3R. Accordingly, assuming that a higher voltage side power supply voltage is EVDD, and lower voltage side power supply voltage is 0 (ground), the reference voltages, i.e., a voltage VIH (high level input voltage) at the node N1, and a voltage VIL (low level input voltage) at the node N2 will be 0.7 EVDD and 0.3 EVDD, respectively. The intermediate voltage detecting section 33 compares the reference voltages and an output of the transmission gate section 21 (voltage C at the selection external input terminal) by the operational amplifiers (comparators) OP1 and OP2. In the case that VIL (0.3 EVDD)<C<VIH (0.7 EVDD), outputs of the operational amplifiers OP1 and OP2 are both set to a high level, and therefore a high level voltage (detection signal A) is outputted from the AND circuit.

In this example, a voltage range of the intermediate voltage is assumed to be 0.3 EVDD<C<0.7 EVDD. The voltage range of the intermediate voltage can be arbitrarily set by adjusting a resistance ratio of the resistors R₁, R₂, and R₃. Alternatively, if the resistors R₁, R₂, and R₃ are replaced by variable resistors, the voltage range can be arbitrarily changed ex post facto by a control signal even after semiconductor chip was formed.

It should be noted that in the present embodiment, when the intermediate voltage is not detected, preferably an enable signal (for example, supplied from the control section 22) is set to 0$ and a current from the power supply EVDD to the power supply EVSS is cut. Thus, current consumptions at the operational amplifiers (comparators) OP1 and OP2 can be reduced.

Also, in the present embodiment, it is preferable to mount only one test circuit 11 in a whole of the microcomputer 1. This is to reduce a cost and an installation area. It should be noted that when only one test circuit 11 is mounted, t′e number of transmission gate permission bits to be simultaneously selected is adapted to be one. On the other hand, when the number of transmission gate permission bits to be simultaneously selected is increased, it is only necessary to increase the number of test circuits 11 according to the number of transmission gate permission bits. Thus, a plurality of external input terminals can be simultaneously monitored.

In the present embodiment, the detection signal is passed to the on-chip debug emulator 4. Therefore, even during debugging on the embedded software development system, an intermediate voltage problem can be found early by the ALARM lamp 20 of the on-chip debug emulator 4, a display screen of the debugging unit 5, and the like. Thus, the developer can take essential measures. As a result, a development time for the embedded system can be shortened.

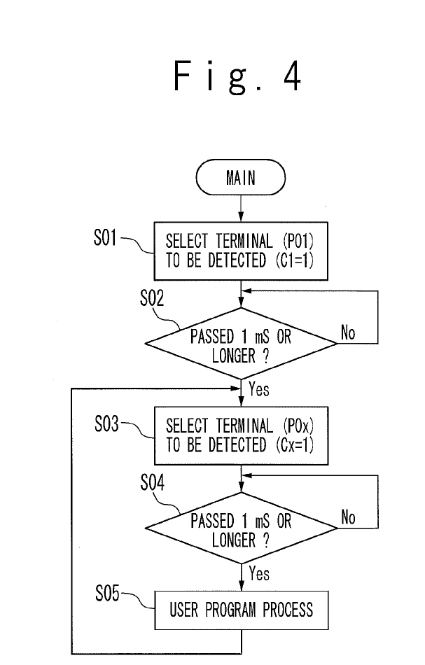

Next, an operation of the microcomputer and the embedded software development system according to the first embodiment of the present invention will be described. FIG. 4 is a flowchart illustrating the operations of the microcomputer and the embedded software development system according to the first embodiment of the present invention.

In response to an instruction from the debugging unit 5 to the CPU 13 based on an input of a developer, or based on settings of the software stored in the RAM 15 or the ROM 14 in advance, the CPU 13 selects one selection external input terminal from the external input terminals P00 to P07, and outputs a signal indicating the selection result to the control section 22. For example, assuming that the external input terminal P01 is selected as the selection external input terminal, the CPU 13 outputs the signal indicating the selection of the external input terminal P01 to the control section 22.

In each of the transmission gate permission bits of the memory 31 of the control section 22, “0” is written as an initial value. The control section 22 writes “1” in a transmission gate permission bit in the memory 31 for the transmission gate corresponding to the selection external input terminal, and “0” in the other transmission gate permission bits, respectively. For example, the control section 22 writes “1” in the transmission gate permission bit C1 in the memory 31 for the transmission gate TG1 corresponding to the external input terminal P01, and “0” in the other transmission gate permission bits C0, and C2 to C7, respectively.

The control section 22 outputs the selection signal S to the transmission gate for which “1” is written as the transmission gate permission bit. Based on the selection signal S, the target transmission gate in the transmission gate section 21 is turned ON. As a result, the intermediate voltage detecting section 33 of the detecting section 23 starts to monitor a voltage at a target selection external input terminal. For example, when “1” is written in the transmission gate permission bit C1, the control section 22 outputs the selection signal S1 to the transmission gate TG1. The transmission gate TG1 in the transmission gate section 21 is turned ON in response to the selection signal S1. As a result, the intermediate voltage detecting section 33 of the detecting section 23 starts to monitor a voltage at the selection external input terminal P01 (Step S01).

If a preset time, for example, 1 msec. has passed (Step S02: Yes), the CPU 13 selects another selection external input terminal from the external input terminals P00 to P07 in response to an instruction from the debugging unit 5 to the CPU 13 based on an input of the developer, or based on the settings of the software stored in the RAM 15 or the ROM 14 in advance, and outputs a signal indicating the selection result to the control section 22. For example, assuming that the external input terminal P07 is selected as the selection external input terminal, the CPU 13 outputs the signal indicating the selection of the external input terminal P07 to the control section 22.

In response to the signal indicating the selection, the control section 22 writes “1” in a transmission gate permission bit in the memory 31 for a transmission gate corresponding to the selection external input terminal, and “0” in the other transmission gate permission bits. For example, the control section 22 writes “1” in the transmission gate permission bit C7 in the memory 31 for the transmission gate TG7 corresponding to the external input terminal P07, and “0” in the other transmission gate permission bits C0 to C6.

The control section 22 outputs the selection signal S to the transmission gate for which “1” is written in the transmission gate permission bit. The target transmission gate in the transmission gate section 21 is turned ON in response to the selection signal S. As a result, the intermediate voltage detecting section 33 of the detecting section 23 starts to monitor a voltage at the target selection external input terminal. For example, when “1” is written in the transmission gate permission bit C7, the control section 22 outputs the selection signal S7 to the transmission gate TG7. The transmission gate TG7 in the transmission gate section 21 is turned ON in response to the selection signal S7. As a result, the intermediate voltage detecting section 33 of the detecting section 23 starts to monitor a voltage at the selection external input terminal P07 (Step S03).

If the preset time, for example, 1 esec. has passed (Step S04: Yes), Steps S03 and S04 may be continuously performed for the other external input terminal, or alternatively the other user program processing step (Step S05) may be inserted, and then Steps S03 and S04 may be continuously performed for the other external input terminal.

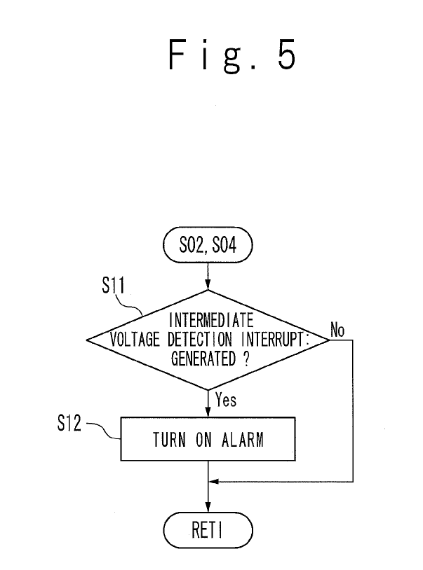

Here, an operation in the case where the intermediate voltage is detected before the preset time, e.g. 1 msec. passes in Step S02 or S04 will be described. FIG. 5 is a flowchart illustrating the operation in the case where the intermediate voltage is detected, according to the first embodiment of the present invention. If detecting the intermediate voltage (Step S11: Yes), the intermediate voltage detecting section 33 outputs the detection signal A. The AND circuit 35 directly receives the detection signal A, and indirectly receives it through the delay circuit 34 as the delay signal B, and outputs a result of the AND (product) operation of the both as the intermediate voltage detection signal D. It should be noted that a delay time of the delay circuit 34 is substantially the same as a waiting time, e.g. 1 msec. at Step S02 or S04. The output of the intermediate voltage detection signal D from the detecting section 23 means that the generation of the intermediate voltage is determined.

In response to the intermediate voltage detection signal D outputted from the detecting section 23, “1” is set in the interrupt status register 38 of the interrupt control section 24. The vector table address generating circuit 37 of the interrupt control section 24 generates the interrupt processing signal VTA, and outputs it to the CPU 13 in response to the intermediate voltage detection signal D. The CPU 13 jumps to an address at which a vector table for vector interrupt processing is arranged, and performs a process in the case of the intermediate voltage generation. Thus, even embedded software can check a hardware malfunction, and therefore the appropriate process can be performed.

On the other hand, the intermediate voltage detection signal D is also outputted to the on-chip debug emulator 4 and the debugging unit 5. Thus, the on-chip debug emulator 4 and the debugging unit 5 receive the intermediate voltage detection signal D. The on-chip debug emulator 4 lights the ALARM lamp 20 to notify the generation of the intermediate voltage (Step S12). Further/alternatively, the generation of the intermediate voltage may be displayed on the display unit of the debugging unit 5. Thus, the developer can recognize the generation of the intermediate voltage during software development.

As described above, an unintended input of the intermediate voltage (due to an abnormal input from an external unit, disconnection due to deterioration or the like of an input path of the microcomputer, or the like) can be detected. As a result, even the developer of the embedded software and software itself can check the hardware problem (intermediate voltage) based on the intermediate voltage detection signal D to the interrupt control section 24, lighting of the ALARM lamp 20 of the on-chip debug emulator 4, and a warning function of the debugging unit 5. Thus, hardware and software developers can perform debugging in collaboration with each other, and therefore a development time to be shortened.

Also, the microcomputer 1 of the present embodiment has the detection circuit 11 in itself, and therefore if the microcomputer is brought into the input state of the intermediate voltage after delivery of the microcomputer mounted in a set product, measures such as a minimum measure (exemplification: notification of the malfunction to a user of the microcomputer by lighting the lamp or the like) can be taken by operating the detection circuit 11 during a normal operation of the microcomputer system. Thus, reliability of the system using the chip set can be improved.

### Second Embodiment

First$ FIG. 1 is a block diagram illustrating a configuration of a microcomputer and an embedded software development system according to a second embodiment of the present invention. The configuration of the microcomputer and the embedded software development system in the second embodiment is the same as that in the first embodiment, and therefore description thereof is omitted.

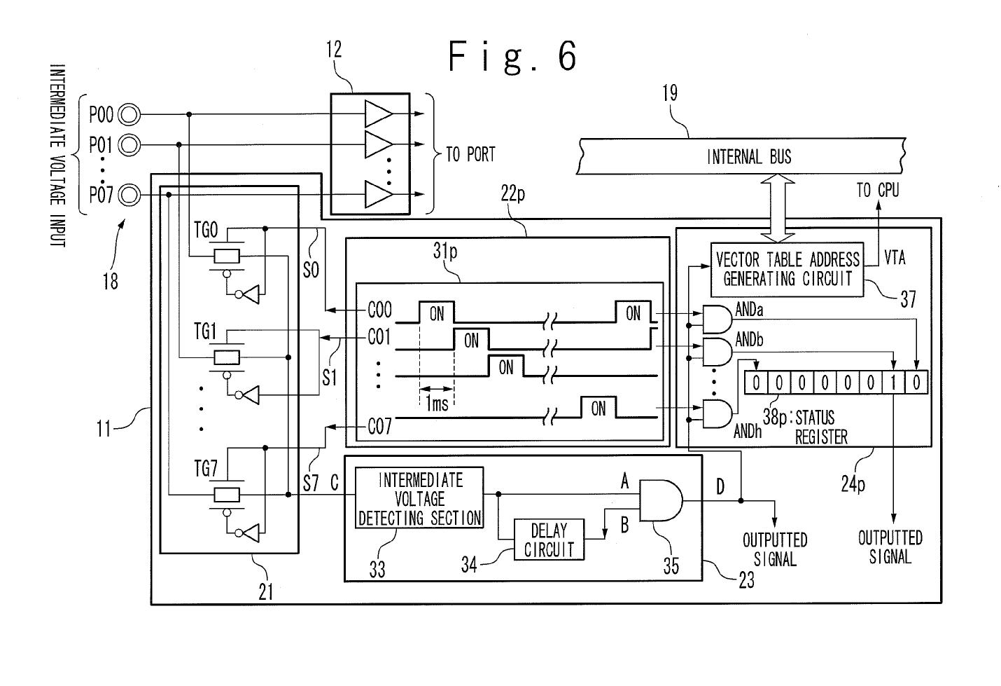

The present embodiment is different from the first embodiment in the configuration of a test circuit 11. Details of the test circuit 11 will be described with reference to FIG. 6. The test circuit 11 includes a transmission gate section 21, a control section 22p, a detecting section 23, and an interrupt control section 24p. The present test circuit 11 is different from that of the first embodiment in configurations and operations of the control section 22p and the interrupt control section 24p.

The control section 22p outputs a selection signal to the transmission gate section 21 to sequentially select the selection external input terminal from external input terminals 18 one by one at predetermined time intervals. The control section 22p has a transmission gate control circuit 31p that operates on the basis of a signal from the CPU 13.

In the first embodiment, only an external terminal at which the intermediate voltage is desired to be detected is selected on the basis of data of the transmission gate permission bits. That is, in the control of the transmission gates, the software (CPU 13) sets in the memory 31 of the control section 22, a transmission gate permission bit corresponding to the external input terminal at which the intermediate voltage is desired to be detected. Accordingly, the detecting section 23 monitors a voltage at the one external input terminal corresponding to the transmission gate permission bit.

On the other hand, in the present embodiment, all of the external input terminals are finally automatically selected in sequence one by one at predetermined time intervals (exemplification: 1 msec.). That is, in the control of the transmission gates, a transmission gate control circuit 31p turns on the transmission gates one by one at the predetermined time intervals. Accordingly, the detecting section 23 can sequentially monitor voltages at the external input terminals one by one at the predetermined time intervals.

In the example of the diagram, the number of the external input terminals is eight (P00 to P07), and therefore a selection signal S0 represented by an output voltage C00 is first outputted to a transmission gate TG0 at a first predetermined time interval. This turns on the transmission gate TG0. As a result, the detecting section 23 monitors a voltage at the external input terminal P00 as the selection input terminal. Then, at a second predetermined time interval, a selection signal S1 represented by an output voltage C01 is outputted to a transmission gate TG1. This turns on the transmission gate TG1. As a result, the detecting section 23 monitors a voltage at the external input terminal P01 as the selection input terminal. The same procedure can also be applied to the other external input terminals. Lastly, at an eighth predetermined time interval, a selection signal S7 represented by an output voltage C07 is outputted to a transmission gate TG7. This turns on the transmission gate TG7. As a result, the detecting section 23 monitors a voltage at the external input terminal P07 as the selection input terminal. After completion of a series of checks to all of the external input terminals in this manner, voltages are again continuously monitored from the external input terminal P00.

The interrupt control section 24p notifies an interrupt processing signal VTA to the CPU 13 on the basis of an intermediate voltage detection signal D. The interrupt control section 24p includes an interrupt status register 38p, a vector table address generating circuit 37, and AND circuits ANDa to ANDh.

The output voltages C00 to C07 are respectively supplied to the AND circuits ANDa to ANDh and the intermediate voltage detection signal D is supplied to all the AND circuits ANDa to ANDh, which output AND operation results (intermediate voltage detection signals D) to corresponding bits of the interrupt status register 38p. That is, the ANDa circuit is supplied with the output voltage C00 at the one input terminal thereof and the intermediate voltage detection signal D from the detecting section 23 at the other input terminal thereof, and outputs the AND operation result of them to a first bit of the interrupt status register 38p. The ANDb circuit is supplied with the output voltage C01 at the one input terminal thereof and the intermediate voltage detection signal D from the detecting section 23 at the other input terminal thereof, and outputs the AND operation result of them to a second bit of the interrupt status register 38p. The same procedure can also be applied to the other AND circuits. Lastly, the ANDh circuit is supplied with the output voltage C07 at the one input terminal thereof and the intermediate voltage detection signal D from the detecting section 23 at the other input terminal thereof, and outputs the result of the AND operation of them to a eighth bit of the interrupt status register 38p.

The interrupt status register 38p stores data having interrupt status bits corresponding to the external input terminals 18. In the example of the diagram, data having the interrupt status bits (8 bits) corresponding to the eight external input terminals 18 (P00 to P07) is stored. The data of the interrupt status bits is read by the on-chip debug emulator 4 or the debugging unit 5.

If the intermediate voltage is detected, and the intermediate voltage detection signal D is outputted, an external input terminal, which was a monitoring object at the time of the detection, corresponds to an ON signal of any of the output voltages C00 to C07. Accordingly, by performing the AND operations of the intermediate voltage detection signal D and the output voltages C00 to C07 in the ANDa to ANDh circuits, and finding out a bit corresponding to an operation result of “1”, on which of the external input terminals the intermediate voltage is generated can be determined. In the interrupt status register 38p, “1” indicates the generation (detection) of the intermediate voltage obtained in this manner, and a corresponding external input terminal. The interrupt status register 38p is read by the CPU 13, the on-chip debug emulator 4, or the debugging unit 5.

It should be noted that the high level signals (output voltages C00 to C07) are also supplied to the interrupt control section 24p at the predetermined time intervals (e.g. 1 msec.), and therefore the interrupt status bits are also set at the predetermined time intervals (e.g. 1 msec.). The CPU 13 (software) can know the detection of the generation of the intermediate voltage and corresponding external input terminal only by checking the interrupt status bits.

The vector table address generating circuit 37 generates the interrupt processing signal VTA 13 in response to the intermediate voltage detection signal D, to output it to the CPU. The interrupt processing signal VTA is a vector table address signal indicating an address of a vector interrupt process performed at the time of the intermediate voltage generation. Thus, a hardware malfunction can be checked in even embedded software, and therefore an appropriate process can be performed.

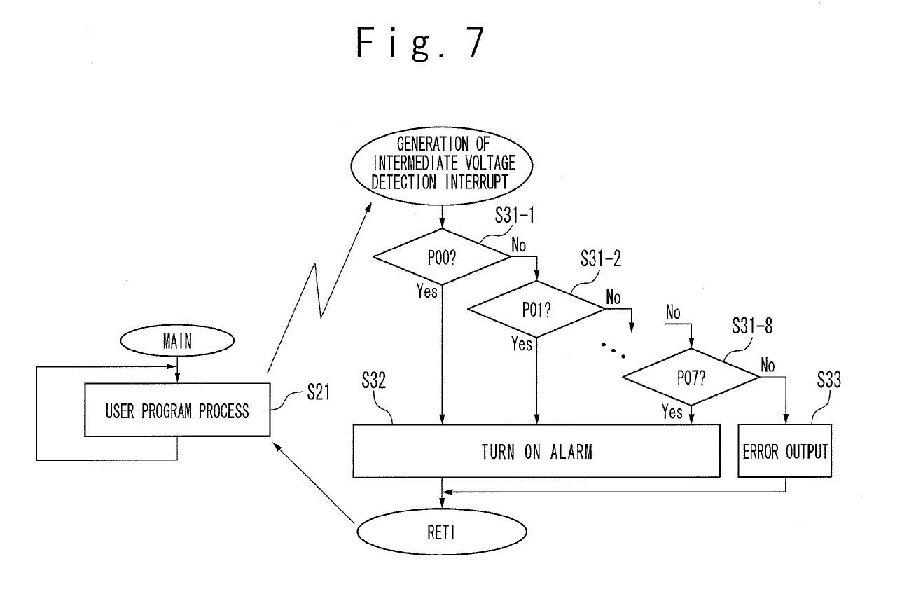

Next, an operation of the microcomputer and the embedded software development system according to the second embodiment of the present invention will be described. FIG. 7 is a flowchart illustrating the operation of the microcomputer and the embedded software development system according to the second embodiment of the present invention.

The CPU 13 executes a user program process in response to an instruction from the debugging unit 5 to the CPU 13 by an input of a developer, or on the basis of settings of software stored in the RAM 15 or the ROM 14 in advance (Step S21). Along with this, the CPU 13 instructs (the control section 22p of) the test circuit 11 to monitor the external input terminals 18 in response to an instruction from the debugging unit 5 to the CPU 13 by the input of the developer, or on the basis of settings of the software preliminarily stored in the RAM 15 or the ROM 14. The control section 22p outputs the selection signal S to the transmission gate section 21 to sequentially select the selection external input terminals from the external input terminals 18 one by one at the predetermined time intervals.

First, the selection signal S0 represented by the output voltage C00 is outputted to the transmission gate TG0 in the first time period. This turns on the transmission gate TG0. As a result, the detecting section 23 monitors a voltage at the external input terminal P00 as the selection input terminal. If the intermediate voltage is detected within the first time period, the detecting section 23 outputs the intermediate voltage detection signal D. The ANDa circuit of the interrupt control section 24p is supplied with the output voltage C00 at the one terminal thereof, and if the intermediate voltage detection signal D from the detecting section 23 is present, supplied with it at the other input terminal thereof. Only when both of the signals are supplied, a high level signal of the AND operation result is outputted to the first bit of the interrupt status register 38p.

In the same manner, the selection signals S1 to S7 represented by the output voltages C01 to C07 are sequentially outputted to the transmission gates TG1 to TG7 at the second to eighth time periods, respectively. Thas sequentially turns on the transmission gates TG1 to TG7. As a result, the detecting section 23 sequentially monitors voltages at the external input terminals P01 to P07 as the selection input terminals. If the intermediate voltage is detected within t′e predetermined time, the detecting section 23 outputs the intermediate voltage detection signal D. In the ANDb to ANDh circuits of the interrupt control section 24p, the output voltages C01 to C07 are supplied to the one input terminal respectively, and if the intermediate voltage detection signal D from the detecting section 23 is present, it is supplied to the other input terminal. Only when both of the signals are supplied, the high level signal of the AND operation result is outputted to second to eighth bits of the interrupt status register 38p.

After completion of the series of checks of the external input terminals in this manner, voltages are continuously monitored from the external input terminal P00 again.

If the intermediate voltage detection signal D is outputted, it is outputted also to the on-chip debug emulator 4 through the dedicated input terminal section 17 and a connector 8. The on-chip debug emulator 4 (or debugging unit 5) reads the content of the interrupt status register 38p in response to the intermediate voltage detection signal D. That is, the on-chip debug emulator 4 first reads a first register (first one from right) of the interrupt status register 38p. This register corresponds to the external input terminal P00. When a value of the first register is “1”, the generation of the intermediate voltage at the external input terminal P00 is shown (Step S31-1: Yes). In this case, the on-chip debug emulator 4 lights an ALARM lamp (e.g. LED) of the emulator 4 for the external input terminal P00 (Step S32). At this time, since the intermediate voltage is detected, the vector table address generating circuit 37 generates the interrupt processing signal VTA in response to the intermediate detection signal D, to output to the CPU 13. The CPU 13 jumps to an address at which a vector table for vector interrupt processing is arranged, and executes the process for the case of the intermediate voltage generation. Thus, a hardware malfunction can be checked by the embedded software, and therefore the appropriate process can be executed.

When the value of the first register is “0” (Step S31-1: No), a second register (second one from right) of the interrupt status register 38p is read (Step S31-2). This register corresponds to the external input terminal P01. The fact that a value of the second register is “1” means the generation of the intermediate voltage at the external input terminal P01 (Step S31-2: Yes). In this case, the on-chip debug emulator 4 lights an ALARM lamp (e.g. LED) the emulator 4 for the external input terminal P01 (Step S32). The operations by the vector table address generating circuit 37 and the CPU 13 at this time are as described above. When the value of the second register is “0” (Step S31-2: No), a third register (third one from right) of the interrupt status register 38p is read (Step S31-3). The same process can also be applied to the other registers. Lastly, when a value of an eighth register (eighth one from right) is “0” (Step S31-8: No), the interrupt status register 38 stores nothing even though the generation of the intermediate voltage is detected (intermediate voltage detection signal D is outputted), so that the determination of a malfunction is made, and an error is outputted (Step S33). Regarding the error, an error lamp (e.g. LED) of the on-chip debug emulator 4 may be lit, or the error may be displayed on a screen of the debugging unit 5.

Also in the present embodiment, a same effect as that of the first embodiment can be obtained. In addition, in the present embodiment, by lighting of the ALARM lamp 20 of the on-chip debug emulator 4 corresponding to each of the external input terminals, at which of the external input terminal the intermediate voltage is generated can be notified to a developer. Further, in the present embodiment, the external input terminals are automatically continuously monitored, and therefore possibility of overlooking the intermediate voltage generation can be reduced.

### Third Embodiment

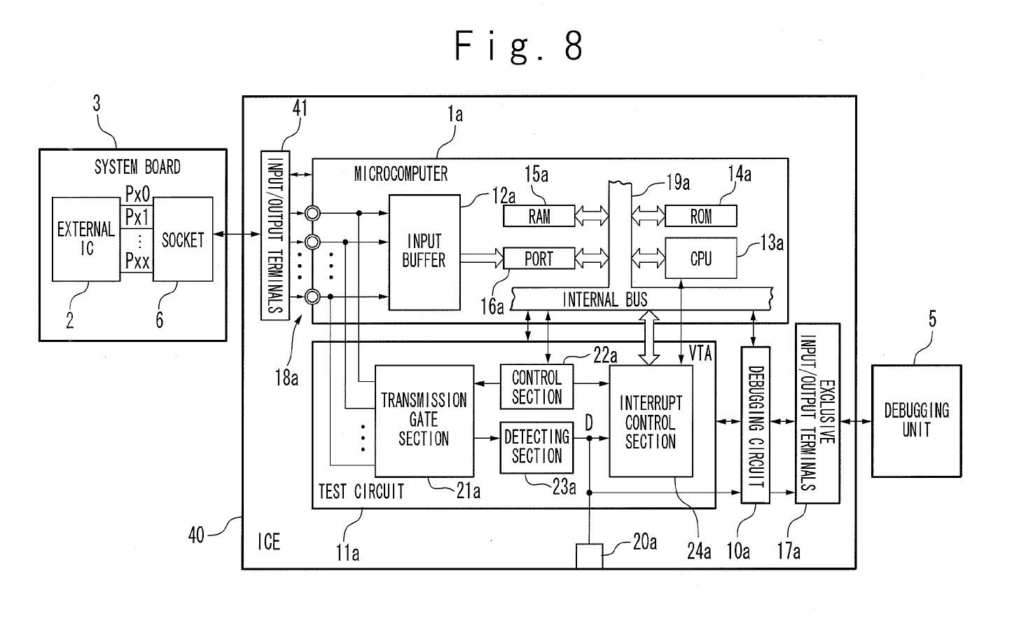

FIG. 8 is a block diagram illustrating t′e configuration of the software development system according to the third embodiment of the present invention. Referring to FIG. 8, the configuration of the microcomputer and the embedded software development system according to a third embodiment of the present invention will be described. The software development system includes an ICE 40 and the debugging unit 5.

The ICE 40 refers to an In-Circuit Emulator. The ICE 40 can emulate a function of a semiconductor chip (microcomputer) to be debugged. The ICE 40 includes an input/output terminal section 41, a microcomputer 1a, a test circuit 11a, a debugging circuit 10a, and a dedicated input/output terminal section 17a. The ICE 40 is connected to a socket 6 mounted with a semiconductor chip in the system board 3 by the input/output terminal 41 and a dedicated cable so as to be bi-directionally communicable. The input/output terminal section 41 is connected to the external input terminals 18a of the microcomputer 1a. Also, the ICE 40 is connected to the debugging unit 5 so as to be bi-directionally communicable.

The present embodiment is different from the first embodiment in that not a semiconductor chip (microcomputer) itself to be de'ugged but the microcomputer la provided in the ICE 40 is used as a microcomputer for performing a debugging operation. The microcomputer la can emulate the semiconductor chip (microcomputer) to be debugged. In the present embodiment, the test circuit 11a is provided in the ICE 40. However, any of the check circuits 11 of the first and second embodiments can be used as the test circuit 11a.

It should be noted that the external input terminals 18a, an input buffer 12a, a CPU 13a, a ROM 14a, a RAM 15a, a PORT 16a, and an internal bus 19a in the microcomputer 1a of the present embodiment respectively correspond to the external input terminals 18, the input buffer 12, the CPU 13, the ROM 14, the RAM 15, the PORT 16, and the internal bus 19 in the microcomputer 1 of FIG. 1. Also, the debugging circuit 10a and a dedicated input/output terminal section 17a respectively correspond to the debugging circuit 10 and the dedicated input/output terminal section 17 of FIG. 1.

An operation of the present embodiment is the same as the operations of the first and second embodiments except that not the semiconductor chip to be debugged but the circuit having a function that emulates the semiconductor chip to be debugged in the ICE 40 is used as a microcomputer, and therefore description thereof is omitted.

Also, in this case, a same effect as those of the first and second embodiments can be obtained.

It should be noted that, in FIG. 8, the ICE 40 emulates the microcomputer 1a not including the test circuit 11a. However, the present invention is not limited to this example. That as, in FIG. 8, the IEC 40 can also emulate a microcomputer including the test circuit and/or the debugging circuit, similarly to the microcomputers 1 of the first and second embodiments. Also, in such a case, a same effect as t'ose of the first to third embodiments can be obtained.

The present invention is not limited to the above embodiments, and it would be obvious that the respective embodiments can be appropriately varied or modified within the technical scope of the present invention. Also, the respective embodiments can be mutually used unless a technical contradiction mutually occurs.

What is claimed is:

1. A microcomputer comprising:
a CPU core section;
a plurality of external input terminals; and
a testing section configured to select a selection external input terminal from said plurality of external input terminals, detect an intermediate voltage of said selection external input terminal, and output an interrupt processing signal related to the detection of the intermediate voltage to said CPU core section.

2. The microcomputer according to claim 1, wherein said testing section outputs an intermediate voltage detection signal to indicate the detection of the intermediate voltage when the intermediate voltage is detected.

3. The microcomputer according to claim 1, wherein said testing section comprises:
an interrupt control section configured to output the interrupt processing signal to said CPU core section when the intermediate voltage is detected.

4. The microcomputer according to claim 1, wherein said testing section comprises:
a signal selection control section configured to select the selection external input terminal from said plurality of external input terminals.

5. The microcomputer according to claim 1, wherein said testing section comprises:
a signal selection control circuit configured to select said selection external input terminals one by one from said plurality of external input terminals at predetermined time intervals.

6. The microcomputer according to claim 5, wherein said testing section comprises:
an interrupt status register configured to indicate whether or not the intermediate voltage is detected in each of said plurality of external input terminals.

7. The microcomputer according to claim 4, wherein said testing section comprises:
a detecting section configured to perform an intermediate voltage detecting operation to each of said plurality of external input terminals; and
said detecting section detects the intermediate voltage through a proportional calculation by use of resistances, a high level input voltage, and a low level input voltage.

8. An embedded software development system comprising:
a debugging target circuit configured to emulate an operation of a microcomputer as a target of a debugging operation;
a debugger to which said debugging target circuit is connected; and
a testing section connected with a plurality of external input terminals of said debugging target circuit, and configured to select a selection external input terminal from said plurality of external input terminals, detect an intermediate voltage of the selection external input terminal, and output an intermediate voltage detection signal to said debugger to indicate the intermediate voltage.

9. The embedded software development system according to claim 8, wherein said testing section comprises:
an interrupt control section configured to output an interrupt processing signal related to the detection of the intermediate voltage to a CPU core section when the said intermediate voltage is detected.

10. The embedded software development system according to claim 8, wherein said testing section comprises:
a signal selection control circuit configured to select the selection external input terminal from said plurality of external input terminals.

11. The embedded software development system according to claim 10, wherein said signal selection control circuit outputs a selection signal indicating the selection external input terminal to said debugger,
said testing section outputs the intermediate voltage detection signal to said debugger when detecting the intermediate voltage in the selection external input terminal, and
said debugger displays a data indicating which of said plurality of external input terminals the intermediate voltage is detected at, on a screen of said debugger based on the selection signal and the intermediate voltage detection signal.

12. The embedded software development system according to claim 8, wherein said testing section comprises:
a signal selection control circuit configured to select the selection external input terminals one by one from said plurality of external input terminals at predetermined time intervals.

13. The embedded software development system according to claim 12, wherein said testing section comprises an interrupt status register configured to indicate whether or not the intermediate voltage is detected in each of said plurality of external input terminals, and outputs a data of said interrupt status register to said debugger, and outputs the intermediate voltage detection signal to said debugger, when detecting the intermediate voltage in said selection external input terminal, and
said debugger displays a data indicating which of said plurality of external input terminals the intermediate voltage is detected at, to a screen of said debugger based on the data and the intermediate voltage detection signal.

14. The embedded software development system according to claim 8, wherein said testing section comprises a determining section configured to detect the intermediate voltage in each of said plurality of external input terminals, and
said determining section adjusts a voltage range which detects the said intermediate voltage by a proportional calculation based on a high level input voltage, a low level input voltage and resistances.

15. The embedded software development system according to claim 8, wherein the selection of said selection external input terminal is performed based on an instruction from said debugger.
